(19) United States
(12) Patent Application Publication
(10) Pub. No.: US 2010/0255339 A1
(43) Pub. Date: Oct. 7, 2010

(54) PLATED ALUMINUM PRODUCT

(76) Inventors: Tomoyuki Sato, Nagano (JP); Masashi Suganuma, Nagano (JP); Tomonori Karasawa, Nagano (JP); Shoji Kanai, Nagano (JP); Akira Matsumoto, Nagano (JP)

Correspondence Address: Bruce L. Adams, ESQ.;ADAM & WILKS, 17 Battery Place, Suite 1231, New York, NY, 10004, US

(21) Appl. No.: 12/734,437

(22) PCT Filed: Sep. 2, 2009
(86) PCT No.: PCT/JP2009/065614

§ 371 Date: Apr. 30, 2010

(30) Foreign Application Priority Data
Sep. 26, 2008 (JP) 2008-248933
Jun. 26, 2009 (JP) 2009-152711

(51) Int. Cl. B32B 15/18; B05D 1/00; B32B 15/20

(52) U.S. Cl. 428/653; 427/436

(57) ABSTRACT

A technique for using an iron plating for coating an aluminum product that results in adequate durability. An aluminum piston (10) used as a plated aluminum product is covered by an iron-based composite plating layer (11). The iron-based composite plating layer (11) contains a carbon nanomaterial, which is applied to the aluminum-based base material using a iron-based composite plating bath formed by mixing a carbon nanomaterial into an iron plating bath.

### TECHNICAL FIELD

The present invention relates to a plated aluminum product whose wear resistance is enhanced.

### BACKGROUND ART

The combination of a cast iron cylinder and an aluminum alloy piston has traditionally been used in, e.g., internal combustion engines; however, light alloys are being increasingly used in cylinders as part of an effort to reduce vehicle weight in order to cut fuel consumption. An aluminum alloy is a popular light alloy.

The piston moves at high speed within the cylinder in a reciprocating motion in the axial direction; tilting of a connecting rod (“con rod” hereafter”) results in the piston being subject to a thrust force in a direction orthogonal to the axis. The thrust force causes strong contact between a skirt section of the piston and the cylinder, resulting in friction, and wear of a sliding section. Wear of the sliding section results in seizing or other problems. In particular, due to the severe wear occurring between like aluminum alloy surfaces, plating is applied to an inner, peripheral surface of the cylinder or a surface of the piston.

Techniques for applying a hardening treatment to a surface of an aluminum piston are already known, as disclosed in Japanese Patent No. 3274718 and Japanese Patent Application Laid-Open Publication No. 2006-292119 A (JP 2006-292119 A).

In a piston disclosed in Japanese Patent No. 3274718, a plurality of ring grooves and land sections is formed on a crown section of a body of an aluminum alloy piston; an anodic oxide coating layer is formed on at least a top surface, a top land section, and a top ring groove section; and an iron plating layer is formed on the surface except on a piston pin hole section of a skirt section of the piston body. In other words, an aluminum piston whose surface has been iron-plated is disclosed in Japanese Patent No. 3274718.

FIG. 14 hereof shows a piston disclosed in JP 2006-292119 A. A piston 100 in FIG. 14 is laminated with an iron plating layer 102 on an outer peripheral surface of an aluminum substrate 101, and a chromium plating layer 103 is formed on the iron plating layer 102.

However, the iron plating layer 102 has inadequate wear resistance (durability) despite being more effective than aluminum in preventing scuffing (a phenomenon in which a part of the piston surface welds, resulting in abrasion damage) and high-temperature adhesion wear. Additionally, there is room for improvement in terms of energy loss due to friction resistance that occurs during sliding, which cannot be ignored in terms of cutting fuel consumption.

There is known a technique in which an anode oxide film (“alumite”) is applied to the uppermost (top) piston ring groove, as disclosed in Japanese Patent No. 3274718. However, the technique requires both an alumite treatment step and an iron plating step, presenting issues in terms of cost and production efficiency.

Durability can be improved by applying a chromium plating layer 103 as disclosed in JP 2006-292119 A; however, this requires both an iron plating step and a chromium plating step, resulting in higher production cost. The high toxicity of hexavalent chromium means that detoxification of the discharge liquid is an important part in the chromium plating process, again resulting in higher production cost.

There is accordingly a need for a technique for coating an aluminum product that results in adequate durability and sliding properties, and through which adequate durability can be obtained with an iron plating process alone.

### DISCLOSURE OF THE INVENTION

An objective of the present invention is to provide a technique for coating an aluminum product that results in adequate durability using an iron plating. Another objective of the present invention is to provide a coating technique that can shorten the treatment process and offer advantages in terms of cost and efficiency.

According to the present invention, there is provided a plated aluminum product which is comprised of an aluminum-based base material; and an iron-based composite plating layer containing a carbon nanomaterial, which is applied to the aluminum-based base material using an iron-based composite plating bath formed by admixing a carbon nanomaterial into an iron plating bath.

An iron-based composite plating layer containing a carbon nanomaterial thus has a smaller friction coefficient and greater durability than a mere iron plating layer. A plated aluminum product with high durability and exceptional sliding properties can be obtained in one plating process.

Preferably, the carbon nanomaterial is a particle-deposited carbon nanomaterial on whose surface SiC particles have been deposited in advance. Having the particle-deposited carbon nanomaterial added in a smaller proportion than the carbon nanomaterial yields a plated aluminum product with high durability and exceptional sliding properties.

Desirably, the aluminum-based base material is preferably a cylinder in a cylinder block, or a piston that moves along the cylinder. Therefore, an aluminum piston or an aluminum cylinder can readily be used as an engine component because the issue of durability can be resolved. Aluminum has a smaller specific gravity compared to cast iron, helping the weight of the engine to be reduced.

### BRIEF DESCRIPTION OF THE DRAWINGS

FIG. 1 is a cross-sectional view of a piston and a cylinder according to the present invention;

FIG. 2 is an expanded view of section 2 of FIG. 1;

FIG. 3 is a schematic view of an electroplating apparatus;

FIG. 4 is a view showing an example of a method of manufacturing a particle-deposited carbon nanofiber;

FIG. 5 is a schematic view of a completely formed particle-deposited carbon nanofiber (partially cut away);

FIG. 6 is an enlarged view of a surface of sample B;

FIG. 7 is a view illustrating a procedure of measurement during a durability test;

FIG. 8 is a graph showing a relationship between the proportion of carbon nanofiber added and the coefficient of kinetic friction;

FIG. 9 is a graph showing a relationship between the proportion of carbon nanofiber added and the depth of wear mark;

FIG. 10 is a graph showing a relationship between the proportion of carbon nanofiber added and surface roughness;

FIG. 11 is a graph showing a relationship between the number of exposed carbon nanofibers and coefficient of kinetic friction;

FIG. 12 is a graph showing a relationship between the number of exposed carbon nanofibers and depth of wear mark;

FIG. 13 is a graph showing a relationship between the number of exposed carbon nanofibers and surface roughness; and

FIG. 14 is a cross-section view of a conventional piston.

### BEST MODE FOR CARRYING OUT THE INVENTION

Preferred embodiments of the present invention are described below with reference to the accompanying drawings. A piston and a cylinder of an internal combustion engine are described as illustrative examples of an aluminum-based base material. However, the scope of the aluminum-based base material is not limited to a piston or a cylinder.

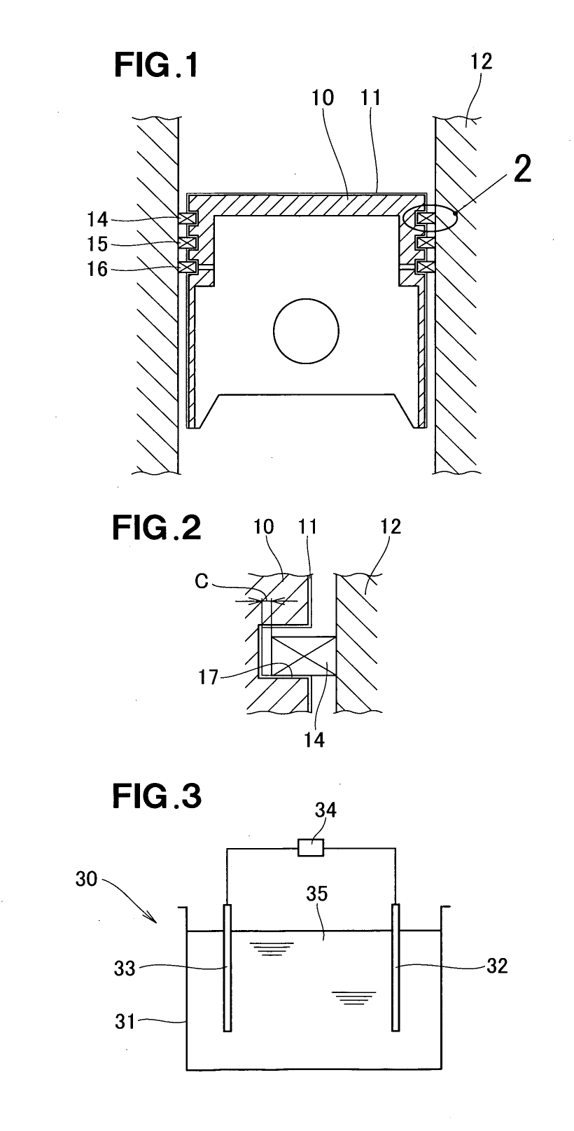

As shown in FIG. 1, an aluminum piston 10 used as a plated aluminum product is covered by an iron-based composite plating layer 11. A cylinder 12 is made of either cast iron or aluminum. Three ring grooves are provided on the piston 10, into which two compression rings 14, 15 and an oil ring 16 (piston ring) are fitted.

As shown on FIG. 2, a ring groove 17 for accommodating the compression ring 14 is coated in the iron-based composite plating layer 11. The compression ring 14 is a sealing member for preventing combustion gas from flowing between the piston 10 and the cylinder 12 from the top to the bottom with respect to FIG. 2. A gap (clearance) C is provided between a bottom of the ring groove 17 and the compression ring 14 so that the sealing function (of the compression ring 14) is maintained even if the piston 10 thermally expands and the outer diameter changes. The ring groove 17 may experience wear because the compression ring 14 slides in the gap C.

In the present embodiment, the ring groove 17 is covered with a hard iron-based composite plating layer 11, eliminating a need for forming an anodic oxide coating or a masking process for the same. Therefore, the treatment process can be dramatically shortened, and advantages accrue in terms of production cost and manufacturing efficiency. In addition, because the iron plating contains carbon nanofibers, wear resistance and heat conductivity can be improved (described in detail below), and heat from an upper surface of the piston can be dispersed effectively from the ring groove 17 via the piston ring. The configuration for the compression ring 14 described above also applies to the compression ring 15 and the oil ring 16 shown in FIG. 1.

Details of the iron-based composite plating layer described above will now be described.

FIG. 3 is a schematic diagram of an electroplating apparatus. An electroplating apparatus 30 is an apparatus in which an iron plate 32 used as a positive electrode is lowered into a plating tank 31, an aluminum-based base material 33 used as a negative electrode is lowered into the plating tank, a power supply 34 is connected to the iron plate 32 and the aluminum-based base material 33, and the plating tank 31 is filled with the following composite plating solution (“plating solution” hereafter) 35. Mixing means and circulation means for mixing and circulating the plating solution 35 are necessary, but a description will be omitted because known means can be used.

The plating solution 35 is a composite plating solution based on an iron plating bath (water, iron sulfate, ammonium sulfate, and urea), into which an appropriate amount of carbon nanofibers or particle-deposited carbon nanofibers is mixed. A method for manufacturing the particle-deposited carbon nanofibers will now be described.

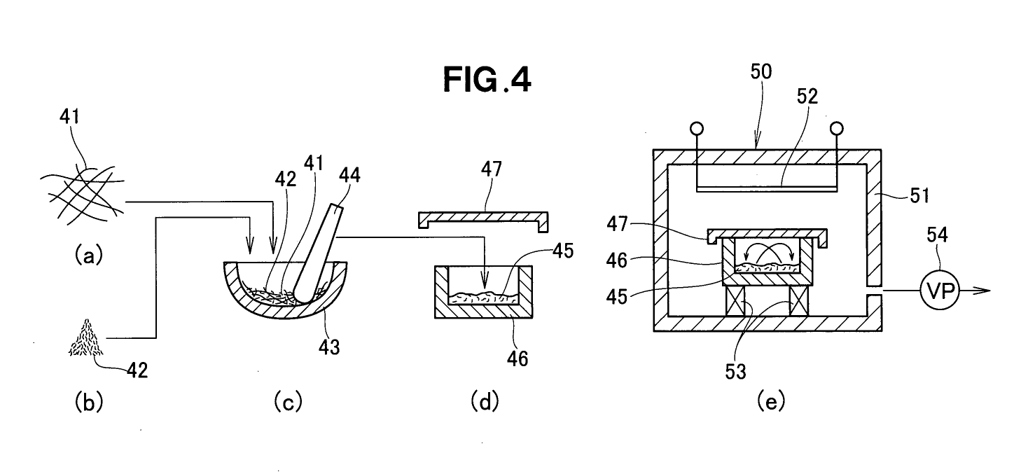

FIG. 4 shows an example of a method for manufacturing particle-deposited carbon nanofibers.

(a): Carbon nanofibers 41 are provided in a quantity of, e.g., 10 g.

(b): A Si powder 42 is provided as particles to react with carbon and form a compound. The powder is used in a quantity of, e.g., 10 g.

(c): The carbon nanofiber 41 and the Si powder 42 are placed in a mortar, and mixed with a pestle for 15 to 30 minutes.

(d) A resulting mixture 45 is placed in an alumina container 46 and covered with an alumina lid 47. The lid 47 is not airtight, so that air can pass between the interior and the exterior of the container 46.

(e): There are provided a vacuum furnace 50, comprising of a sealed furnace 51; heating means 52 for heating the interior of the furnace 51; platforms 53, 53 on which the container 46 is placed; and a vacuum pump 54. The container 46 is placed within the vacuum furnace 50.

Heating under a vacuum causes the Si powder in the mixture 45 to evaporate. The evaporated Si contacts a surface of the carbon nanofibers, forms a compound, and adheres as SiC particles.

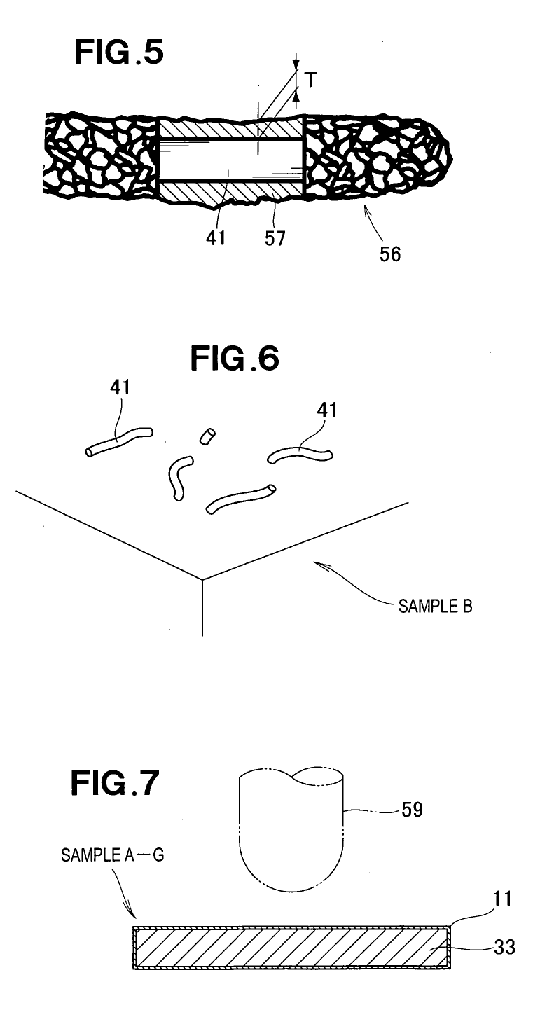

FIG. 5 is a schematic diagram of a completely formed particle-deposited carbon nanofiber (partially cut away), and illustrates the view under an electron microscope. The particle-deposited carbon nanofiber 56 is comprised of a carbon nanofiber 41 that forms a core, and a particle layer 57 substantially uniformly coating the surface of the carbon nanofiber 41. The thickness T of the particle layer 57 is between 20 nm and 80 nm, with about 50 nm being the average thickness.

When the particle-deposited carbon nanofiber was subject to X-ray diffraction, no Si peak was observed, while C and SiC peaks were observed. The Si particles likely changed into SiC as a result of the contact.

An experiment was conducted to study whether there is a difference in properties (in particular, wear resistance (durability) and coefficient of kinetic friction (sliding property)) of resulting iron-based composite plating layers between an instance where particle-deposited carbon nanofibers described above are added to an iron plating bath, an instance where ordinary carbon nanofibers (i.e., having no particles deposited thereon) are added to an iron plating bath, and an instance where a iron plating bath is used without anything being added thereto. In the experiment, an Si-based aluminum plate (AC8A) was used as an aluminum-based base material.

### Example of an Experiment

An example of an experiment relating to the present invention will now be described. The present invention is not limited in scope to the example of the experiment.

### Creation of Samples A to J:

A plurality of samples was created in order to measure the coefficients of kinetic friction and depths of wear marks. The associated details are shown in Table 1 below.

TABLE 1

| | | | | Treatment conditions | | | No. of |
|---|---|---|---|---|---|---|---|
| | Base | Plating solution | | Bath | Current | Time | exposed CNFs/ |
| Sample | material | Base | Additive | temp. | density | (min) | (30 μm × 30 μm) |
| A | Si-based | Iron | None | 55° C. | 15 A/dm² | 5 | — |
| B | Al plate | plating | CNF, 1.0 g/L | 55° C. | 2 A/dm² | 10 | 30 |
| C | (AC8A) | bath | CNF, 1.5 g/L | 40° C. | 2 A/dm² | 10 | 123 |
| D | | | CNF, 2.0 g/L | 40° C. | 4 A/dm² | 5 | 141 |
| E | | | Si-CNF(1:5) | 55° C. | 4 A/dm² | 10 | 47 |
| | | | 1.2 g/L(*1.0 g/L) | | | | |
| F | | | Si-CNF(1:2) | 55° C. | 5 A/dm² | 10 | 67 |
| | | | 1.5 g/L(*1.0 g/L) | | | | |
| G | | | Si-CNF(1:1) | 55° C. | 4 A/dm² | 5 | 89 |
| | | | 2.0 g/L(*1.0 g/L) | | | | |
| H | | | CNF, 3.0 g/L | 55° C. | 4 A/dm² | 5 | 53 |
| I | | | CNF, 3.0 g/L | 55° C. | 2 A/dm² | 10 | 119 |
| J | | | CNF, 5.0 g/L | 55° C. | 2 A/dm² | 10 | 222 |

Sample A was created by immersing an aluminum plate in an iron plating bath (containing no additives) and applying an iron plating. The bath temperature was 55° C., the current density was 15 A/dm², and the time was 5 minutes.

For sample B there was used a composite plating bath made by adding carbon nanofibers (CNF) to an iron plating bath at a proportion of 1.0 g per liter. Sample B was created by immersing an aluminum plate in the composite plating bath and applying an iron plating. The bath temperature was 55° C., the current density was 2 A/dm², and the time was 10 minutes.

FIG. 6 is an expanded conceptual diagram of a surface of the sample B. Under a microscope, exposed carbon nanofibers 41 were observed to extend out like hairs from the surface of the sample B. Counting the number of the exposed carbon nanofiber 41 showed there to be 30 per 30 μm×30 μm area. This value is shown on the third row of the rightmost column of Table 1.

Sample C was created by changing the proportion in which the carbon nanofibers were added in sample B to 1.5 g/L, modifying some of the treatment conditions, and applying an iron-based composite plating. The number of exposed CNFs was 123.

Sample D was created by changing the proportion in which the carbon nanofibers were added in sample B to 2.0 g/L, modifying some of the treatment conditions, and applying an iron-based composite plating. The number of exposed CNFs was 141.

For sample E there was used a composite plating bath made by adding particle-deposited carbon nanofibers (Si—CNF) to an iron plating bath in a proportion of 1.2 g per liter. A Si:CNF ratio of 1:5 was used for sample E. A conversion calculation (1.2×(⅚)=1.0) shows that with sample E, the carbon nanofibers were admixed into the iron plating bath at a ratio of 1.0 g per liter.

The sample E was created by immersing an aluminum plate in the composite plating bath and applying an iron-based composite plating. The bath temperature was 55° C., the current density was 4 A/dm², and the time was 10 minutes. The number of exposed CNFs (or, more accurately, the number of particle-deposited carbon nanofibers) was 47.

For sample F there was used a composite plating bath made by adding particle-deposited carbon nanofibers (Si—CNF) to an iron plating bath in a proportion of 1.5 g per liter. A Si:CNF ratio of 1:2 was used for sample F. A conversion calculation (1.5×(⅔)=1.0) shows that with sample F, the carbon nanofibers were admixed into the iron plating bath at a ratio of 1.0 g per liter.

The sample F was created by immersing an aluminum plate in the composite plating bath and applying an iron-based composite plating. The bath temperature was 55° C., the current density was 4 A/dm², and the time was 10 minutes. The number of exposed CNFs (or, more accurately, the number of particle-deposited carbon nanofibers) was 67.

For sample G there was used a composite plating bath made by adding particle-deposited carbon nanofibers (Si—CNF) to an iron plating bath in a proportion of 2.0 g per liter. A Si:CNF ratio of 1:1 was used for sample G. A conversion calculation (2.0×(½)=1.0) shows that with sample G, the carbon nanofibers were admixed into the iron plating bath at a ratio of 1.0 g per liter

The sample G was created by immersing an aluminum plate in the composite plating bath and applying an iron-based composite plating. The bath temperature was 55° C., the current density was 4 A/dm², and the time was 5 minutes. The number of exposed CNFs (or, more accurately, the number of particle-deposited carbon nanofibers) was 89.

Sample H was created by applying an iron-based composite plating, the conditions used for sample B being changed so that the proportion in which the carbon nanofiber was added was 3.0 g/L, the current density was 4 A/dm², and the time was 10 minutes. The number of exposed CNFs was 53.

Sample I was created by applying an iron-based composite plating, the proportion in which the carbon nanofiber was added in Sample B being changed to 3.0 g/L. The number of exposed CNFs was 119.

Sample J was created by applying an iron-based composite plating, the proportion in which the carbon nanofiber was added in Sample B being changed to 5.0 g/L. The number of exposed CNFs was 222.

FIG. 7 is a view illustrating a procedure of measurement during a durability test. A testing rod 59, shown by an imaginary line, is provided in proximity to samples A through G in which an aluminum-based base material 33 is coated with an iron plating layer or an iron-based composite plating layer 11. The test is conducted by rubbing the testing rod 59 onto the iron plating film or the iron-based composite plating film 11. An alumina (Al₂O₃) testing rod having a distal end provided with a spherical surface that was 10 mm in diameter (lower end in the drawing) was used for the testing rod 59. The testing rod 59 was made to contact (the coating) with a pushing force of 50 g, and was caused to move in a reciprocating motion for 50 cycles over a distance of 4 mm at a speed of 0.5 mm/s with no lubrication.

The measured value for the coefficient of kinetic friction exhibits large fluctuations during the first 5 cycles of reciprocation, but stabilizes after 20 to 40 cycles; a stable value was obtained with 50 cycles.

The depth of a wear mark that appeared on the surface of the iron plating layer or the iron-based composite plating layer 11 was measured using a laser microscope.

The surface roughness of the sample (before the durability test measurement) was measured using a surface roughness meter.

The coefficients of kinetic friction, depths of wear marks, and surface roughness measured as above are shown in Table 2. In Table 2, entries for “additive” and “exposed CNFs” shown in Table 1 are copied to the right of the column for the sample.

TABLE 2

| | | | No. of | Coeff. of | Depth of | |
|---|---|---|---|---|---|---|
| | | | exposed | kinetic | wear | Surface |
| Exp. no. | Sample | Additive | CNFs | friction | mark | roughness |
| 1 | A | None | — | 0.50 | 0.92 μm | 0.084 μm |
| 2 | B | CNF, 1.0 g/L | 30 | 0.31 | 0.63 μm | 0.131 μm |
| 3 | C | CNF, 1.5 g/L | 123 | 0.20 | 0.20 μm | 0.206 μm |
| 4 | D | CNF, 2.0 g/L | 141 | 0.18 | 0.06 μm | 0.187 μm |
| 5 | E | *CNF, 1.0 g/L | 47 | 0.25 | 0.12 μm | 0.139 μm |
| 6 | F | *CNF, 1.0 g/L | 67 | 0.20 | 0.08 μm | 0.096 μm |
| 7 | G | *CNF, 1.0 g/L | 89 | 0.22 | 0.05 μm | 0.082 μm |
| 8 | H | CNF, 3.0 g/L | 53 | 0.21 | 0.24 μm | 0.139 μm |
| 9 | I | CNF, 3.0 g/L | 119 | 0.15 | 0.21 μm | 0.131 μm |
| 10 | J | CNF, 5.0 g/L | 222 | 0.14 | 0.26 μm | 0.220 μm |

Experiment 1 was conducted on sample A (iron plating layer not containing CNF). The coefficient of kinetic friction was 0.50, the wear mark depth was 0.92 μm, and the surface roughness was 0.084 μm.

Experiments 2, 3, and 4 were conducted on samples B, C, and D, which have an iron-based composite plating layer containing CNFs, and the coefficients of friction, depths of wear marks, and surface roughness shown on Table 2 were obtained.

Experiments 5, 6, and 7 were conducted on samples E, F, and G, which have an iron-based composite plating layer containing particle-deposited CNFs, and the coefficients of friction, depths of wear marks, and surface roughness shown on Table 2 were obtained.

Experiments 8, 9, and 10 were conducted on samples H, I, and J, which have an iron-based composite plating layer containing CNFs, and the coefficients of friction, depths of wear marks, and surface roughness shown on Table 2 were obtained.

Next, correlations between the proportion in which the carbon nanofibers were added and the coefficient of kinetic friction, depth of wear mark, and surface roughness were investigated.

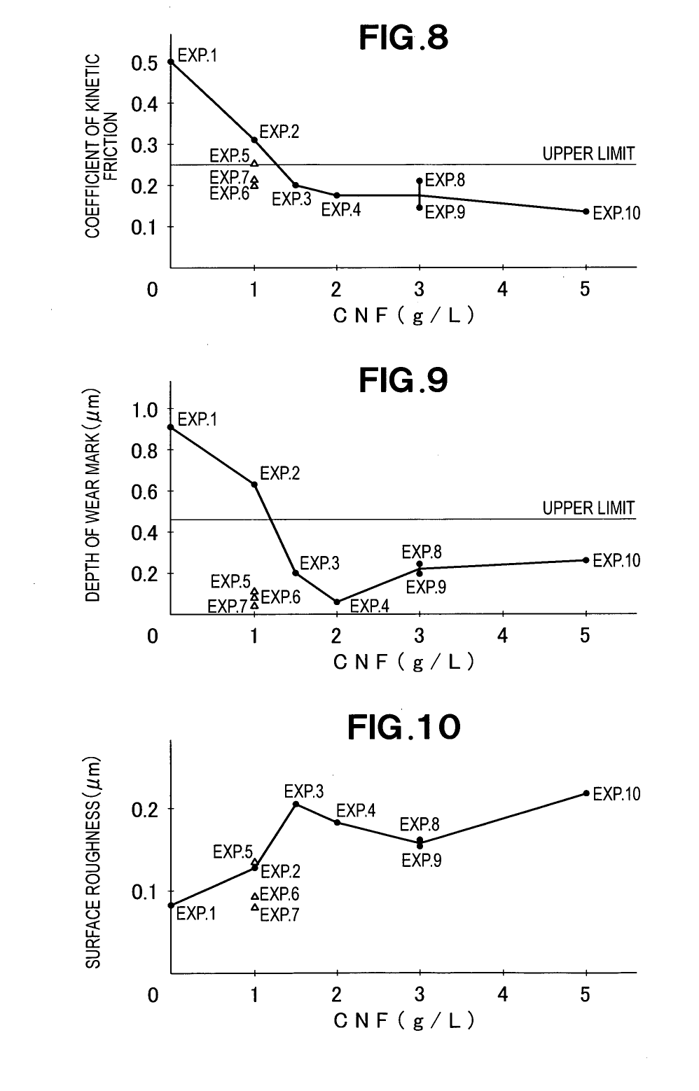

FIG. 8 is a graph showing a relationship between the proportion in which the carbon nanofibers were added and the coefficient of kinetic friction; a point labelled “Exp. 1” on the graph corresponds to a coefficient of kinetic friction of 0.50 with sample A according to Table 2. Sample A has no carbon nanofiber added. Therefore, the point “Exp. 1” was plotted at a position with co-ordinates of 0 along the horizontal axis and 0.5 along the vertical axis. Points “Exp. 2” through “Exp. 10” were plotted in a similar manner to point “Exp. 1”.

With regards to the coefficient of kinetic friction, a larger value results in a larger mechanical energy loss in the engine, so that a smaller value is preferable.

With sample A, iron plating not containing an additive was applied to an aluminum base material. A coefficient of kinetic friction of 0.50 was obtained as a result of experiment 1 conducted using the sample A. A coefficient of kinetic friction that is considerably smaller than 0.50 is required as an accomplishment of the invention. Therefore, a value half that of the coefficient of kinetic friction obtained in experiment 1 (0.50/2) was set as an upper limit to the value of the coefficient of kinetic friction. A line corresponding to the upper limit of 0.25 is shown on the graph.

A value that is below the line representing the upper limit is preferable. Specifically, coefficients of kinetic friction are sufficiently small in experiments 3, 4, 8, 9, and 10. Because the proportion in which the CNF was added in experiment 3 is 1.5 g/L, and the proportion in which the CNF was added in experiment 10 is 5.0 g/L, the proportion in which the carbon nanofibers were added may be in a range of between 1.5 and 5.0 g/L. Meanwhile, a proportion in which the carbon nanofibers were added of 1.0 g/L is sufficient for experiments 5, 6, and 7, which are represented by a triangular symbol, and which use a iron-based composite plating layer containing particle-deposited CNF.

FIG. 9 is a graph showing a relationship between the proportion of carbon nanofiber added and the depth of wear mark. The depth of the wear mark affects service life, and is an indicator for measuring durability.

From a viewpoint of durability, a smaller wear mark depth is preferable. The depth of the wear mark obtained in experiment 1 using sample A was 0.92 μm. A wear mark depth considerably smaller than 0.92 μm is required as an accomplishment of the invention. Therefore, a value that is half that of the wear mark depth obtained in experiment 1 (0.92/2) was set as an upper limit to the wear mark depth. A line corresponding to the upper limit of 0.46 is shown on the graph.

A value that is below the line representing the upper limit is preferable. Specifically, the depths of the wear marks are sufficiently small with experiments 3, 4, 8, 9, and 10. Because the proportion of addition of CNF in experiment 3 is 1.5 g/L, and the proportion of addition of CNF in experiment 10 is 5.0 g/L, the proportion in which the carbon nanofibers were added may be in a range of between 1.5 and 5.0 g/L.

There is a trough between experiments 3, 4, 8, and 9. The proportion in which CNFs were added is 1.5 g/L for experiment 3 and 3.0 g/L for experiment 9; therefore, the proportion in which the carbon nanofibers were added may be within the range of 1.5 to 3.0 g/L.

Meanwhile, a proportion in which the carbon nanofibers were added of 1.0 g/L is sufficient for experiments 5, 6, and 7 (represented by the triangular symbol), which use a iron-based composite plating layer containing particle-deposited CNF. In other words, experiments 5 through 7, which use an iron-based composite plating layer containing particle-deposited carbon nanofibers, resulted in high durability despite the small numbers of exposed carbon nanofibers.

FIG. 10 is a graph showing a relationship between the proportion in which the carbon nanofibers were added and surface roughness. The surface roughness is the smallest in experiment 1, which contained no additive. The surface roughness was expected to increase in experiments 2 though 10, which contained additives. The graph shows that, as expected, the surface roughness increases in proportion to the proportion in which the carbon nanofibers were added. However, the surface roughness remains as low as 0.220 μm even in experiment 10, indicating that the roughness can remain at a level that does not present a problem for practical use.

Experiments 5, 6, and 7 (iron-based composite plating layer containing particle-deposited CNF) confirmed that the surface roughness remains sufficiently small.

According to the above-mentioned experiments, a plated aluminum product with high durability can be provided in one plating process by adding a suitable amount of carbon nanofibers or particle-deposited carbon nanofibers to an iron plating bath. Given that there is only one plating process, the production cost relating to the plating process can be reduced.

Next, correlations between the number of exposed carbon nanofibers and the coefficient of kinetic friction, depth of wear mark, and surface roughness were investigated.

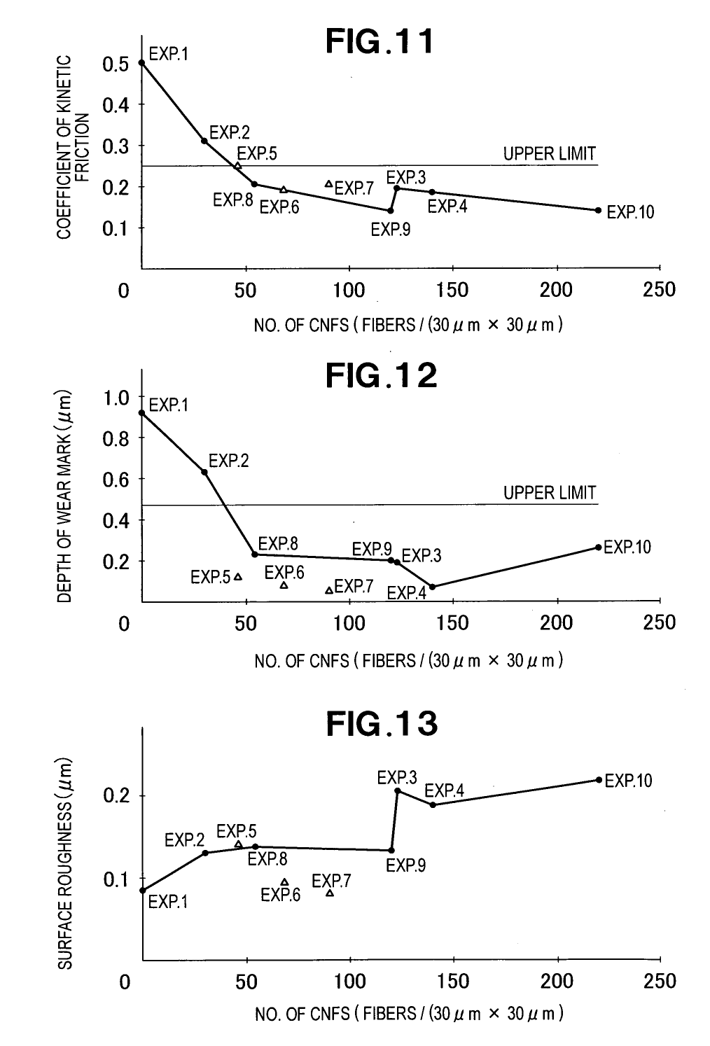

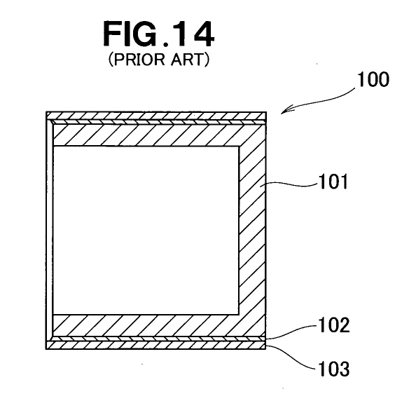

FIG. 11 is a graph showing a relationship between the number of exposed carbon nanofibers and coefficient of kinetic friction; a point labelled “Exp. 2” on the graph corresponds to a coefficient of kinetic friction of 0.31 with sample B, according to Table 2. The number of exposed carbon nanofibers for sample B was 30. Therefore the point was plotted at a location with co-ordinates of 30 on the horizontal axis and 0.31 on the vertical axis. Point 1 and points 3 through 10 were plotted in a similar manner to point 2. The coefficient of kinetic friction was confirmed to be substantially smaller with a lower number of exposed carbon nanofibers.

FIG. 12 is a graph showing a relationship between the number of exposed carbon nanofibers and depth of wear mark. The depth of wear mark is confirmed to be smaller with a higher number of exposed carbon nanofibers. However, in order to increase the number of exposed carbon nanofibers, the amount of addition of carbon nanofibers must be increased; a suitable number of exposed carbon nanofibers is between 50 (experiment 8) and 220 (experiment 10). Use of particle-deposited carbon nanofibers represented by the triangular symbol allows a sufficient effect to be obtained using a smaller number of exposed nanofibers (50 to 90).

The above suggests that exposed carbon nanofibers have a lubricating effect.

FIG. 13 is a graph showing a relationship between the number of exposed carbon nanofibers and surface roughness. The surface roughness is the smallest in experiment 1 because there are no exposed carbon nanofibers. The surface roughness was expected to increase for experiments 2 through 10 for which exposed carbon nanofibers were observed. The graph shows that the surface roughness increases substantially in proportion to the number of exposed carbon nanofibers, as expected. However, the surface roughness remains as low as 0.220 μm even in experiment 10, indicating that the roughness can remain at a level that does not present a problem for practical use.

Experiments 5, 6, and 7 (iron-based composite plating layer containing particle-deposited CNF) confirmed that the surface roughness remains sufficiently small.

Next, the thermal properties of a plated aluminum product according to the present invention were investigated.

A piston that is heated by combustion gas is kept at a thermal equilibrium by dissipating heat to a cylinder via a piston ring. The cooling effect on the temperature of the piston is higher with a higher thermal conductivity from the piston to the piston ring, or from the piston ring to the cylinder. Therefore, the effect of an iron-based composite plating layer that coats the piston or the cylinder needs to be investigated.

Therefore, a circular aluminum alloy (AC8A) plate with a thickness of 2.0 mm, and a plated circular plate made by coating one surface of a 2.0-mm-thick circular aluminum alloy (AC8A) plate with an approximately 20-μm-thick iron-based composite plating layer containing a carbon nanomaterial (formed using a plating solution with 1.0 g/L of CNF) were provided, and the thermal conductivity of each of the two plates were measured. A conventional measuring apparatus was used to measure the thermal conductivities. Results of the measurements are shown in Table 3 below.

TABLE 3

| | Sample | | Thermal | |
|---|---|---|---|---|
| Exp. no. | Base material | Plating | conductivity | Evaluation |
| 11 | 2.0 mm, | none | 114 W/m · K | 1.0 |
| | Si-based Al | | | |
| | plate (AC8A) | | | |
| 12 | 2.0 mm, | Appx. 20 μm | 144 W/m · K | 1.3 |
| | Si-based Al | CNF, 1.0 g/L | | |
| | plate (AC8A) | | | |

In experiment 11, in which no plating was applied, the thermal conductivity was 114 W/m·K. In experiment 12, in which an iron-based composite plating layer containing a carbon nanomaterial was applied, the thermal conductivity was 144 W/m·K. A 1.3-fold increase in the thermal conductivity was observed when the iron-based composite plating was applied, compared to an instance in which no plating was applied. The carbon nanomaterial is thought to be a significant cause of the increase.

The plating technology according to the present invention is applied to a piston or a cylinder of an internal combustion engine; however, the technology can be applied to another vehicle component or a component of industrial machinery.

An effect similar to that of carbon nanofiber was obtained when an experiment was conducted with the carbon nanofiber replaced with carbon nanotubes or fullerenes, though details of the experiment are not provided here. Therefore, the carbon nanomaterial may be any nano-sized carbon material such as carbon nanofibers, carbon nanotubes, or fullerenes, irrespective of form or type.

### INDUSTRIAL APPLICABILITY

The present invention is suitable for use in an aluminum piston.

1. A plated aluminum product comprising:
an aluminum-based base material; and
an iron-based composite plating layer which contains a carbon nanomaterial and which is plated on the aluminum-based base material using an iron-based composite plating bath formed by admixing a carbon nanomaterial into an iron plating bath.

2. The plated aluminum product of claim 1, wherein the carbon nanomaterial is a particle-deposited carbon nanomaterial having SiC particles deposited thereon.

3. The plated aluminum product of claim 1, wherein the aluminum-based base material is a cylinder in a cylinder block, or a piston that moves along a cylinder in a cylinder block.

4. A method of manufacturing a plated aluminum product, comprising the steps:
providing an aluminum-based base material;
admixing a carbon nanomaterial into an iron plating bath to form an iron-based composite plating bath; and
plating an iron-based composite layer containing carbon nanomaterial on the aluminum-based base material using the iron-based composite plating bath.

5. A method according to claim 4; wherein the carbon nanomaterial admixed into the iron plating bath has SiC particles deposited thereon.
